(19) United States
(12) Patent Application Publication
(10) Pub. No.: US 2021/0173629 A1
(43) Pub. Date: Jun. 10, 2021

(54) METHOD FOR REMOTELY UPDATING EMBEDDED VEHICLE SOFTWARE

(71) Applicant: PSA AUTOMOBILES SA, Poissy (FR)

(72) Inventors: Amira DEJEAN, VELIZY VILLACOUBLAY (FR); Arnauld DISABLEU, TAVERNY (FR); Jeremie FOCQUEUR, ERMONT (FR); Nicolas GUYOT, GUYANCOURT (FR)

(21) Appl. No.: 17/045,436

(22) PCT Filed: Mar. 22, 2019
(86) PCT No.: PCT/FR2019/050661

§ 371 Date: Oct. 5, 2020

(30) Foreign Application Priority Data
Apr. 6, 2018 (FR) 1853001

(51) Int. Cl. G06F 8/65; B60W 40/08; G07C 9/00

(52) U.S. Cl. CPC G06F 8/65; B60W 2040/0881; G07C 9/00309; B60W 40/08

(57) ABSTRACT

Method for remotely updating software embedded in a computer storage unit (20) of a vehicle comprising at least one human-machine interface (60) with a display, the method comprising the steps of: detecting a presence of an occupant in the vehicle, if no occupant is present in the vehicle, then the method performs the update remotely and comprises a step of using the display of the human-machine interface (60) in a power-saving mode.

### CROSS-REFERENCE TO RELATED APPLICATIONS

This application is the US National Stage under 35 USC § 371 of International Application No. PCT/FR2019/050661, filed 22 Mar. 2019 which claims priority to French Application No. 1853001 filed 6 Apr. 2018, both of which are incorporated herein by reference.

### BACKGROUND

The present invention concerns in general a method for remotely updating software embedded in a motor vehicle.

In the prior art, methods for updating embedded software are known. For example, KR101091464 describes a method for wireless updating. The charge state of the battery is checked following the receipt of an update message from a remote server. If the battery charge conditions do not satisfy a predetermined condition, then the update message is stored in the memory instead of being displayed. However, this patent proposes no solution for performing an update in power-saving mode.

### SUMMARY

An aim of the present invention is to overcome the above-mentioned drawbacks of the prior art and in particular, firstly, to propose a method for updating software embedded in a vehicle that minimizes power requirements so as to leave the vehicle with an optimum power reserve (in order to re-start or enable reinstallation of the software according to its initial configuration, if an error occurs).

For this, a method for remotely updating software embedded in a computer storage unit of a vehicle comprising at least one human-machine interface with a display is disclosed, the method comprising the steps of:
detecting a presence of an occupant in the vehicle,
if no occupant is present in the vehicle, then performing the update remotely and with the display of the human-machine interface in a power-saving mode. The method, when the occupant is not in the vehicle, performs the update in a power-saving mode, that is to say, without displaying the usual information on the progress of the update. In other words, the method comprises a step of checking that the vehicle is empty and then, in this context, during updating, no information on the progress or status of the update is displayed, which saves the vehicle's power reserves (batteries). This makes available an additional power reserve should it prove necessary to restart another update, or return to the previously installed version (roll back), if an error or incompatibility is detected.

Advantageously, during the step of using the display of the human-machine interface in power-saving mode, the display is used only:
to display a final update report on the at least one human-machine interface, for example on the return of an occupant into the vehicle, and/or
if an occupant re-enters the vehicle before the end of the update. In fact, only one final report is displayed, ideally only on the return of an occupant into the vehicle. However, if an occupant re-enters the vehicle during an update in power-saving mode, then the method can comprise a display step to inform the occupant that the update is in progress.

In other words, the update is performed without sending, during the update, a message providing information on the status or progress of an update on the at least one human-machine interface.

In other words, the update is performed leaving all of the human-machine interface units of the vehicle inactive.

Advantageously, the step of detecting a presence in the vehicle comprises:
a step of detecting a locking action of the vehicle when it is stationary, and/or
a step of sending an interrogative message to the at least one human-machine interface unit and not receiving a response within a preset time, and/or
a step of checking a state of vacancy of the vehicle seats, and/or
a step of checking an absence of an ignition key in the vehicle.

Advantageously, the step of detecting a presence in the vehicle results in the vehicle being deemed to have no occupants if:
the step of sending an interrogative message to the at least one human-machine interface has received no response after a preset time (one minute for example), and if
the step of checking a presence of an ignition key in the vehicle concludes with an absence of key in the vehicle (no presence of a key in a lock cylinder of the steering column, or no detection of a contactless ignition key in the cab interior).

Alternatively, the vehicle can be deemed to be without an occupant if all of the seats are equipped with an occupant-presence sensor and if none of the occupant-presence sensors is activated.

Advantageously, the method for updating comprises an initial step of connecting to a remote server, and of receiving an update request.

Advantageously, the updating step is performed only when the vehicle is stationary.

Advantageously, if an occupant is present in the vehicle, then the update:
is deferred if it is not a priority, and the step of detecting presence is repeated after detecting an opening of a door and/or a locking of the vehicle;
is in any event performed if it is a priority.

Advantageously, if an occupant is present in the vehicle, then the update is preceded by a step of checking a level of power available in the vehicle, and the method comprises a step of displaying an invitation to perform the update by displaying only a final update report on the at least one human-machine interface, if the level of power available in the vehicle is insufficient to perform the update with a use of the at least one human-machine interface during the update. In other words, if an occupant is present, he/she can decide to launch the update by using a so-called power-saving update mode (with no feedback during the update).

Advantageously, the updating step is preceded by a step of checking a level of power available in the vehicle, and the updating step is performed only when the level of power available exceeds a preset minimum reserve.

Advantageously, the updating method comprises a step of reinstalling the initial version of the software if an error or incompatibility is detected during the update.

Advantageously, the updating step is performed by establishing a wireless connection with a remote server. The update is downloaded via a wireless connection (by radio waves).

A second aspect concerns a computer-readable storage medium, with a computer program arranged to execute the method of one of the preceding claims by a computing unit.

A third aspect concerns a motor vehicle, comprising at least one computer-readable storage medium, with a computer program arranged to execute the updating method according to the first aspect by a computing unit of the vehicle. In other words, the implementation of the method is local, that is to say that all of the decision steps are implemented by the vehicle, which avoids the need to communicate with the remote server.

### DESCRIPTION OF THE FIGURES

Further features and advantages of the claimed invention will emerge more clearly from the following detailed description of an embodiment of the claimed invention given purely by way of non-limiting example and shown in the accompanying drawings, in which:

FIG. 1 represents a vehicle with a device managed by software that must be updated according to the method; and

FIG. 2 represents a diagram of the steps implemented by the method.

### DETAILED DESCRIPTION

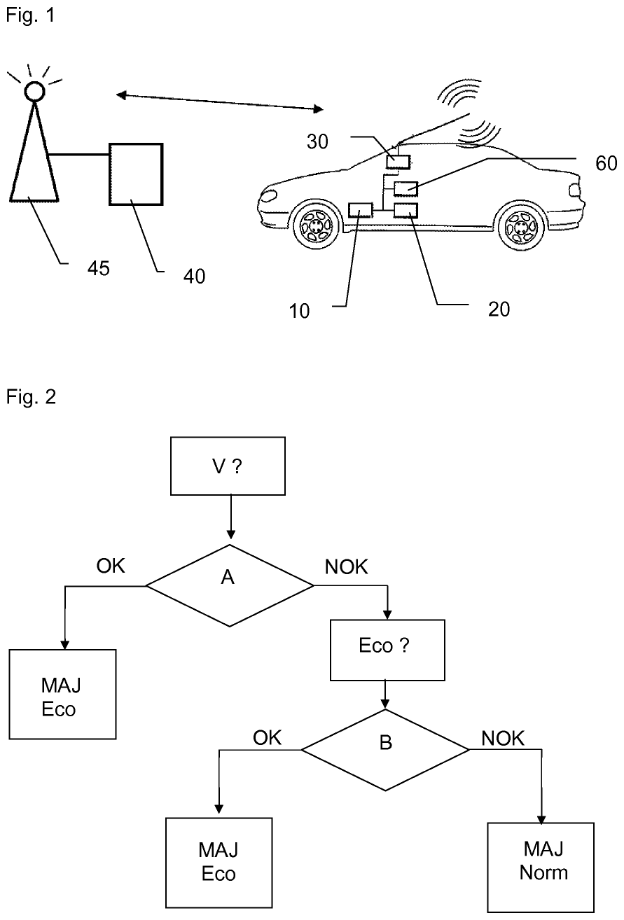

FIG. 1 represents a vehicle comprising a device 10 (for example a fuel injection device, an embedded multimedia system, a vehicle-integrated geo-tracking device, etc.) which is managed or controlled by software stored in a computer storage unit 20.

The vehicle also comprises a human-machine interface 60 with a display that enables, in particular, the display of multimedia information, vehicle parameters or information, etc. Typically, the human-machine interface 60 is a touchscreen located on the dashboard or central console in order to display messages or information for the attention of the driver or occupants of the vehicle.

Due to technical developments, or so as to establish control rules taking feedback into account, it may be necessary to upgrade the software version that controls the device 10 by updating the previous (i.e., currently installed) version to a current (i.e., to be installed) version.

For this purpose, the vehicle comprises a wireless connection unit 30 that enables connection to a remote server 40 via, for example, a telephone relay antenna 45, in order to download a new version of the software and install it in the computer storage unit 20.

The method proposes performing this update while minimizing power requirements. In fact, it may be decided to perform updates only when the vehicle is stationary, only using the power reserves stored in its batteries.

In particular, as shown in FIG. 2, the method can begin by checking whether the vehicle is empty (V?). To do this, the method can check that no ignition key is present in the vehicle, and send a question (for example, a presence validation request) to the human-machine interface 60. If no response has been received after, for example, one minute, the method can determine that the vehicle is empty.

At step A, if the vehicle is empty, then the method performs the update in a power-saving operating mode (MAJ Eco). In particular, the method performs the update without sending a message of monitoring the progress or status of the update on the human-machine interface 60. In other words, the human-machine interface 60 stays off when the vehicle is without an occupant, as do all of the other displays in the vehicle.

Only a final message indicating that an update has been performed is displayed, for example at the next start-up, or when the occupant re-enters the vehicle. As a result, the update has consumed no power to keep a display on.

If, by contrast, the vehicle is not empty, then the method can send a validation request to the occupant asking whether the update should be performed in power-saving mode or not (Eco?).

If the occupant validates this request, then the method can pass to step B and perform the update in a power-saving mode (MAJ Eco), that is to say, by sending only a final report message to the display of the human-machine interface 60.

If the occupant does not validate this request, then at step B, the method can perform the update by displaying constantly or repeatedly, during the update, a status or progress report on this update (MAJ Norm).

Clearly, the method can also check whether the vehicle has sufficient electrical power reserve and propose particular strategies depending on the power reserve available.

In particular, any update can be deferred if the power reserve is insufficient, even in power-saving mode (reserve below a minimum reserve). The method can also defer the update, or force an update in power-saving mode if the power reserve is sufficient to perform the update without using the display during the update, but insufficient to perform the update using the display during the update.

The method can also propose a particular strategy depending on the priority of the update: if the latter is a priority (regulatory update, or update of a security device), then this update is performed without being deferred, even if there is an occupant, or even if it is necessary to perform it in power-saving mode.

If, by contrast, the update is not a priority, then the method can decide to defer the update in order to perform the update in power-saving mode when the vehicle will be empty. This merely involves repeating the step of detecting the absence of an occupant at a later stage (if a door opens and closes, if the status of a seat occupancy changes from “occupied” to “not occupied,” if an ignition key is no longer detected in the vehicle), and if the vehicle is detected to be empty of occupants, then the update can take place.

It will be understood that various modifications and/or improvements obvious to a person skilled in the art can be made to the different embodiments of the method described in the present description without departing from the scope of the invention.

1. A method for remotely updating software embedded in a computer storage unit of a vehicle comprising at least one human-machine interface with a display, the method comprising the steps of:
detecting a presence of an occupant in the vehicle, and
if no occupant is present in the vehicle, then performing the update remotely using the display of the human-machine interface in a power-saving mode.

2. The updating method according to claim 1, wherein during the step of using the display of the human-machine interface in power-saving mode, the display is used only:
to display a final update report on said at least one human-machine interface, and/or
if an occupant re-enters the vehicle before the end of the update.

3. The updating method according to claim 1, wherein the step of detecting a presence in the vehicle comprises:
a step of detecting a locking action of the vehicle when the vehicle is stationary, and/or
a step of sending an interrogative message to said at least one human-machine interface unit and not receiving a response within a preset time, and/or
a step of checking a state of vacancy of the vehicle seats, and/or
a step of checking an absence of an ignition key in the vehicle.

4. The updating method according to claim 1, comprising an initial step of connecting to a remote server, and of receiving an update request.

5. The updating method according to claim 1, wherein the updating step is performed only when the vehicle is stationary.

6. The updating method according to claim 1, wherein if an occupant is present in the vehicle, then the update:
is deferred if it is not a priority update, and the step of detecting presence is repeated after detecting an opening of a door and/or a locking of the vehicle; or
is in any event performed if it is a priority update.

7. The updating method according to claim 1, wherein, if an occupant is determined to be present in the vehicle, then the update is preceded by a step of checking a level of power available in the vehicle; the method further comprising a step of displaying an invitation on the display on said at least one human-machine interface to perform the update by displaying only a final update report on said display if the level of power available in the vehicle is insufficient to perform the update with a use of said at least one human-machine interface during the update.

8. The updating method according to claim 1, wherein the updating step is preceded by a step of checking a level of power available in the vehicle, and wherein the updating step is performed only when the level of power available exceeds a preset minimum reserve.

9. The updating method according to claim 1, comprising a step of reinstalling the initial version of the software if an error or incompatibility is detected during the update.

10. A motor vehicle comprising at least one computer-readable storage medium with a computer program stored therein;
said computer program being arranged to execute the method claim 1 by a computing unit of the vehicle.
